(19) United States
(12) Patent Application Publication
(10) Pub. No.: US 2020/0344094 A1
(43) Pub. Date: Oct. 29, 2020

(54) DIGITAL DATA AND POWER TRANSMISSION OVER SINGLE-WIRE BUS

(71) Applicant: QUALCOMM Incorporated, San Diego, CA (US)

(72) Inventors: Lalan Jee MISHRA, San Diego, CA (US); Joseph DUNCAN, Carlsbad, CA (US); Richard Dominic WIETFELDT, San Diego, CA (US)

(21) Appl. No.: 16/392,235

(22) Filed: Apr. 23, 2019

(51) Int. Cl. H04L 25/49; H04L 12/10; H04L 12/40

(52) U.S. Cl. CPC H04L 25/49; H04L 12/40; H04L 12/10

(57) ABSTRACT

Systems, methods, and apparatus for one wire communication are disclosed. An apparatus has a line driver adapted to power one or more slave devices coupled to a one-wire serial bus, a circuit for encoding and decoding data in signals transmitted over the serial bus, and a controller. The line driver may maintain the wire at or above a voltage base level during transactions conducted over the wire. A data-encoded signal provided by the coding circuit may be transmitted on the wire in a first transaction and a data-encoded signal received from the wire may be decoded during a second transaction. The line driver may power the one or more slave devices when it maintains the wire at or above the first voltage level. The first signal and the second signal transitions within a voltage range defined by the first voltage level and a second voltage level.

### TECHNICAL FIELD

The present disclosure relates generally to serial communication and, more particularly, to providing power for slave devices over a one-wire serial bus.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, which may include a multi-drop serial bus or a parallel bus. General-purpose serial interfaces known in the industry include the Inter-Integrated Circuit (I2C or I²C) serial bus and its derivatives and alternatives. The Mobile Industry Processor Interface (MIPI) Alliance defines standards for I3C, the Radio Frequency Front-End (RFFE) interface and other interfaces.

In one example, the I3C serial bus may be used to connect sensors and other peripherals to a processor. In some implementations, multiple bus masters are coupled to the serial bus such that two or more devices can serve as bus master for different types of messages transmitted on the serial bus. In another example, the RFFE interface defines a communication interface for controlling various radio frequency (RF) front-end devices, including power amplifier (PA), low-noise amplifiers (LNAs), antenna tuners, filters, sensors, power management devices, switches, etc. These devices may be collocated in a single IC device or provided in multiple IC devices. In a mobile communications device, multiple antennas and radio transceivers may support multiple concurrent RF links. In another example, system power management interface (SPMI) defined by the MIPI Alliance provides a hardware interface that may be implemented between baseband or application processors and peripheral components. In some implementations, the SPMI is deployed to support power management operations within a device.

As device complexity increases, demand for input/output pins also increases and there is demand for simplified bus architectures.

### SUMMARY

Certain aspects of the disclosure relate to systems, apparatus, methods and techniques that can support communication with device interfaces that use a single-wire link and that derive power from the wire that carries data between devices.

In various aspects of the disclosure, a method performed at a master device coupled to a serial bus includes using a line driver to drive a wire of a one-wire serial bus to a first voltage level, using the line driver to maintain the wire at or above the first voltage level during each of a plurality of transactions conducted over the one-wire serial bus, participating in a first transaction by transmitting a first signal on the wire, and decoding second data from a second signal received from the wire during a second transaction conducted over the one-wire serial bus. The line driver may power a slave device coupled to the one-wire serial bus when it maintains the wire at or above the first voltage level. The first signal and/or the second signal transitions within the voltage range defined by the first voltage level and the second voltage level. The first signal may encode first data and transitions within a voltage range defined by the first voltage level and a second voltage level.

In some aspects, the wire is driven by the line driver to the first voltage level during an idle period and before the second transaction commences. Driving the wire to the first voltage level may enable the slave device to generate power before the second transaction commences. The line driver may begin driving the wire at a time indicated by a protocol controller or based on configuration information provided in the serial bus interface of the master device. Data may be transmitted in formats defined or compatible with an I2C, I3C, SPMI and/or RFFE protocol.

In some aspects, the wire is at a ground voltage defined for the master device before the first transaction commences. A bus idle period may be in effect when the wire is at the ground voltage. In some instances, ground voltage may be a zero-volt level defined for the master device, the slave device and/or an IC associated with the master device or the slave device. In one example, the first voltage level and the second voltage level are positive with respect to the ground voltage, where the second voltage has a higher voltage level than the first voltage. In another example, the first voltage level and the second voltage level are negative with respect to the ground voltage, where the second voltage has a lower voltage level than the first voltage. The first data and/or the second data may be encoded using PAM, PWM, PPM or Manchester-encoding. The first signal and/or the second signal may transition between multiple voltage levels within the voltage range defined by the first voltage level and a second voltage level, including when a PAM-4, PAM-8 or Manchester-encoding scheme is used to encode data.

In various aspects of the disclosure, a data communication apparatus has a line driver adapted to couple the apparatus to a wire of a one-wire serial bus and configured to power one or more slave devices coupled to the one-wire serial bus, a coding circuit configured to encode and decode data in one or more signals transmitted over the one-wire serial bus, and a controller. The controller may be configured to cause the line driver to drive the wire to a first voltage level, cause the line driver to maintain the wire at or above the first voltage level during each of a plurality of transactions conducted over the wire, participate in a first transaction by causing the line driver to transmit a first signal provided by the coding circuit and encodes first data, cause the coding circuit to decode second data from a second signal received from the wire during a second transaction. The line driver may power the one or more slave devices when it maintains the wire at or above the first voltage level. The first signal and the second signal transitions within a voltage range defined by the first voltage level and a second voltage level.

In various aspects of the disclosure, a method of data communication includes extracting power from a wire of a one-wire serial bus, participating in a first transaction by receiving a first signal that encodes first data, and encoding second data in a second signal transmitted on the wire during a second transaction. The wire may be maintained at or above a first voltage level during each of a plurality of transactions conducted over the one-wire serial bus. The first signal and the second signal may transition within a voltage range defined by the first voltage level and a second voltage level.

In some aspects, the wire is driven by a master device to the first voltage level during an idle period and before the second transaction commences. The master device may continue driving the wire while the second signal is transmitted. The wire may be at a ground voltage defined for the slave device before the first transaction commences. In another example, the first voltage level and the second voltage level may be positive with respect to the ground voltage. In another example, the first voltage level and the second voltage level may be negative with respect to the ground voltage. In some instances, ground voltage may be a zero-volt level defined for the master device, the slave device and/or an IC associated with the master device or the slave device. In one example, the first voltage level and the second voltage level are positive with respect to the ground voltage, where the second voltage has a higher voltage level than the first voltage. In another example, the first voltage level and the second voltage level are negative with respect to the ground voltage, where the second voltage has a lower voltage level than the first voltage. The first data and/or the second data may be encoded using PAM, PWM, PPM or Manchester-encoding. The first signal and/or the second signal may transition between multiple voltage levels within the voltage range defined by the first voltage level and a second voltage level, including when a PAM-4, PAM-8 or Manchester-encoding scheme is used to encode data

In various aspects of the disclosure, a data communication apparatus configured to operate as a slave device has a power circuit coupled to a wire of a one-wire serial bus and configured to extract power from the wire when the wire is actively driven by another device, a coding circuit configured to encode and decode data in one or more signals transmitted over the one-wire serial bus, and a controller. The controller may be configured to participate in a first transaction by causing the coding circuit to decode first data from a first signal received from the wire, and participate in a second transaction by causing the coding circuit to encode second data in a second signal transmitted on the wire. The wire may be maintained at or above a first voltage level during each of a plurality of transactions conducted over the one-wire serial bus. The first signal and the second signal may transition within a voltage range defined by the first voltage level and a second voltage level.

### BRIEF DESCRIPTION OF THE DRAWINGS

FIG. 1 illustrates an apparatus employing a data link between IC devices that is selectively operated according to one of plurality of available standards.

FIG. 2 illustrates a system architecture for an apparatus employing a data link between IC devices.

FIG. 3 illustrates a device configuration for coupling various radio frequency front-end devices using multiple RFFE buses.

FIG. 4 illustrates a system in which one-wire slave devices are coupled to a 1-Wire serial bus in accordance with certain aspects disclosed herein.

FIG. 5 illustrates a system in which a bus master communicates with parasitically-powered slave devices that may be adapted in accordance with certain aspects disclosed herein.

FIG. 6 illustrates examples of power extraction circuits that may be adapted in accordance with certain aspects disclosed herein.

FIG. 7 illustrates an example of signaling over a conventional one-wire bus parasitic-power extraction circuit is used to power a slave device.

FIG. 8 illustrates a first example of signaling that may be used on a conventional one-wire serial bus when data is encoded using two level PAM encoding.

FIG. 9 illustrates a system that uses a single-wire serial bus to couple a bus master device and a slave device through respective pins in accordance with certain aspects disclosed herein.

FIG. 10 illustrates an example of multi-transactional signaling on a one-wire serial bus coupled to at least one slave device that extracts power parasitically from the data line in accordance with certain aspects disclosed herein.

FIG. 11 illustrates one example of an apparatus employing a processing circuit that may be adapted according to certain aspects disclosed herein.

FIG. 12 is a flowchart that illustrates a method for data communication at a 1-Wire slave device in accordance with certain aspects disclosed herein.

FIG. 13 illustrates an example of a hardware implementation for a 1-Wire slave apparatus adapted in accordance with certain aspects disclosed herein.

FIG. 14 is a flowchart that illustrates a method for data communication at a 1-Wire slave device in accordance with certain aspects disclosed herein.

FIG. 15 illustrates an example of a hardware implementation for a 1-Wire slave apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Devices that include multiple SoC and other IC devices often employ a shared communication interface that may include a serial bus or other data communication link to connect processors with modems and other peripherals. In some implementations, it may be desirable to eliminate interconnections in order to reduce the number general-purpose input/output (GPIO) pins used by the components of a system. A one-wire serial bus or other data communication link may be implemented by refraining from transmitting the clock signal. A one-wire serial bus may be operated in accordance with proprietary or standards-defined protocols including, for example, an I2C, I3C, SPMI, and/or RFFE protocol, or another protocol that may be configured for half-duplex operation. Increased functionality and complexity of operations involving devices coupled to serial buses, together with the imposition of more stringent timing constraints in support of applications, peripherals and sensors can result in greater demand for GPIO pins and increased communication link throughput.

Certain aspects of the disclosure relate to the use of a line driver to drive a data line of a one-wire serial bus to a first voltage level that enables a slave device to extract power from the data line. The line driver may maintain the data line at or above the first voltage level during each of a plurality of transactions conducted over the one-wire serial bus. The line driver may provide sufficient current to power a slave device coupled to the one-wire serial bus when it maintains the data line at or above the first voltage level. A transaction may be conducted using the data line by transmitting or receiving a data-encoded signal on or from the data line. The data-encoded signal may transition within a voltage range defined by the first voltage level and a second voltage level.

Certain aspects disclosed herein may be useable to replace or supplement a serial bus protocol, such as an I2C, I3C, SPMI, and/or RFFE protocol, or point-to-point interfaces based on UARTs, line-multiplexed UARTs (LM-UARTs). Certain aspects are applicable to a serial bus operated in half-duplex mode or full-duplex mode. Certain aspects are applicable to point-to-point interfaces including UART-based interfaces, line multiplexed UART (LM-UART) interfaces. In some implementations, certain aspects disclosed herein may be deployed to support exchange of virtual GPIO (VGI). Certain aspects are applicable to multipoint interfaces and/or interfaces operated in point-to-point mode.

Examples of Apparatus that Employ Serial Data Links

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similar functioning device.

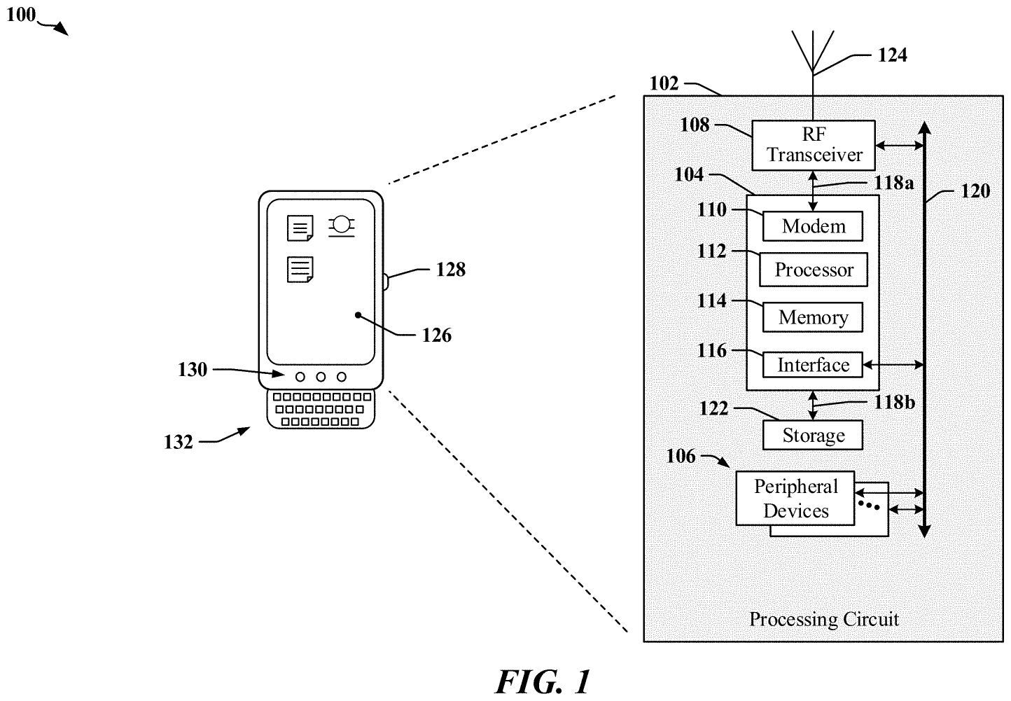

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, etc. through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

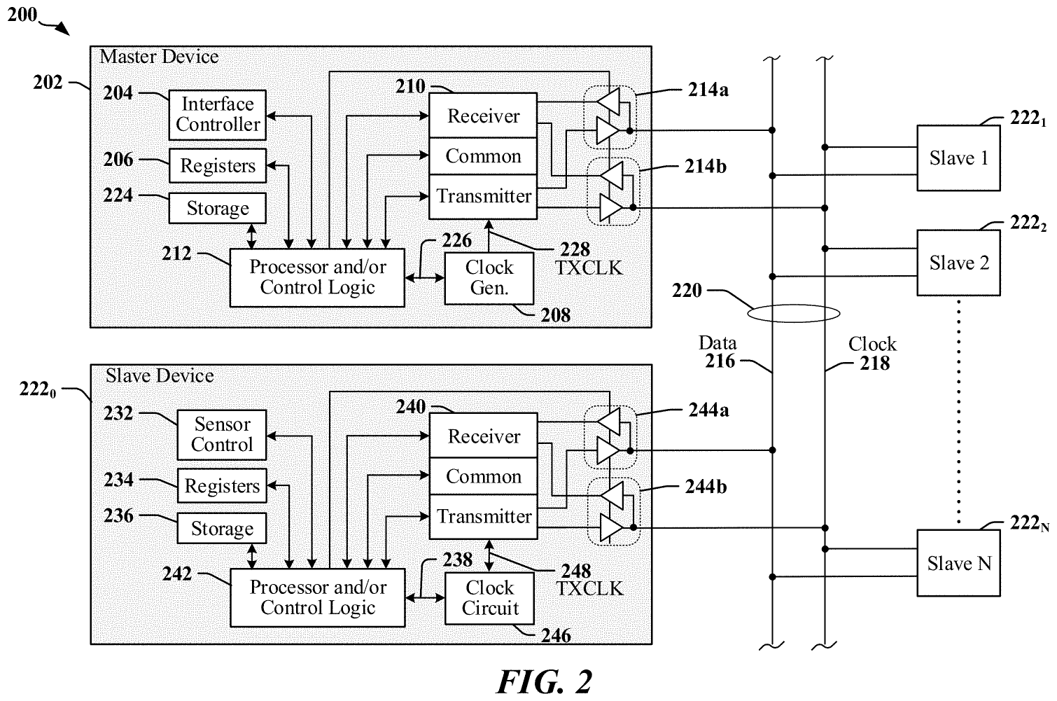

FIG. 2 illustrates certain aspects of an apparatus 200 that includes multiple devices 202, and 222₀-222_{N} coupled to a serial bus 220. The devices 202 and 222₀-222_{N} may be implemented in one or more semiconductor IC devices, such as an applications processor, SoC or ASIC. In various implementations the devices 202 and 222₀-222_{N} may include, support or operate as a modem, a signal processing device, a display driver, a camera, a user interface, a sensor, a sensor controller, a media player, a transceiver, and/or other such components or devices. In some examples, one or more of the slave devices 222₀-222_{N} may be used to control, manage or monitor a sensor device. Communications between devices 202 and 222₀-222_{N} over the serial bus 220 is controlled by a master device 202. Certain types of bus can support multiple master devices 202.

In one example, a master device 202 may include an interface controller 204 that may manage access to the serial bus, configure dynamic addresses for slave devices 222₀-222_{N} and/or generate a clock signal 228 to be transmitted on a clock line 218 of the serial bus 220. The master device 202 may include configuration registers 206 or other storage 224, and other control logic 212 configured to handle protocols and/or higher level functions. The control logic 212 may include a processing circuit such as a state machine, sequencer, signal processor or general-purpose processor. The master device 202 includes a transceiver 210 and line drivers/receivers 214a and 214b. The transceiver 210 may include receiver, transmitter and common circuits, where the common circuits may include timing, logic and storage circuits and/or devices. In one example, the transmitter encodes and transmits data based on timing in the clock signal 228 provided by a clock generation circuit 208. Other timing clocks 226 may be used by the control logic 212 and other functions, circuits or modules.

At least one device 222₀-222_{N} may be configured to operate as a slave device on the serial bus 220 and may include circuits and modules that support a display, an image sensor, and/or circuits and modules that control and communicate with one or more sensors that measure environmental conditions. In one example, a slave device 222₀ configured to operate as a slave device may provide a control function, module or circuit 232 that includes circuits and modules to support a display, an image sensor, and/or circuits and modules that control and communicate with one or more sensors that measure environmental conditions. The slave device 222₀ may include configuration registers 234 or other storage 236, control logic 242, a transceiver 240 and line drivers/receivers 244a and 244b. The control logic 242 may include a processing circuit such as a state machine, sequencer, signal processor or general-purpose processor. The transceiver 210 may include receiver, transmitter and common circuits, where the common circuits may include timing, logic and storage circuits and/or devices. In one example, the transmitter encodes and transmits data based on timing in a clock signal 248 provided by clock generation and/or recovery circuits 246. The clock signal 248 may be derived from a signal received from the clock line 218. Other timing clocks 238 may be used by the control logic 242 and other functions, circuits or modules.

The serial bus 220 may be operated in accordance with RFFE, I2C, I3C, SPMI, or other protocols. At least one device 202, 222₀-222_{N} may be configured to operate as a master device and a slave device on the serial bus 220. Two or more devices 202, 222₀-222_{N} may be configured to operate as a master device on the serial bus 220.

In some implementations, the serial bus 220 may be operated in accordance with an I3C protocol. Devices that communicate using the I3C protocol can coexist on the same serial bus 220 with devices that communicate using I2C protocols. The I3C protocols may support different communication modes, including a single data rate (SDR) mode that is compatible with I2C protocols. High-data-rate (HDR) modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 220, in addition to data formats and aspects of bus control. In some aspects, the I2C and I3C protocols may define direct current (DC) characteristics affecting certain signal levels associated with the serial bus 220, and/or alternating current (AC) characteristics affecting certain timing aspects of signals transmitted on the serial bus 220. In some examples, a 2-wire serial bus 220 transmits data on a data line 216 and a clock signal on the clock line 218. In some instances, data may be encoded in the signaling state, or transitions in signaling state of the data line 216 and the clock line 218.

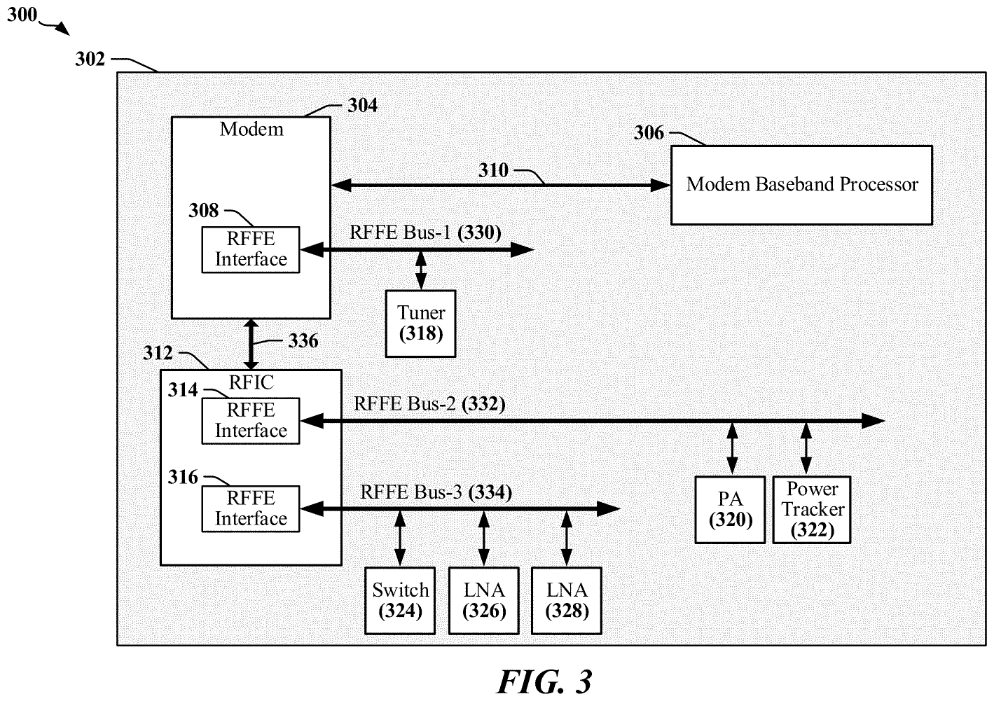

FIG. 3 is a block diagram 300 illustrating a second example of a configuration of communication links in a chipset or device 302 that employs multiple RFFE buses 330, 332, 334 to couple various RF front-end devices 318, 320, 322, 324, 326 328. In this example, a modem 304 includes an RFFE interface 308 that couples the modem 304 to a first RFFE bus 330. The modem 304 may communicate with a baseband processor 306 and a Radio-Frequency IC (RFIC 312) through one or more communication links 310, 336. The illustrated device 302 may be embodied in one or more of a mobile communication device, a mobile telephone, a mobile computing system, a mobile telephone, a notebook computer, a tablet computing device, a media player, a gaming device, a wearable computing and/or communications device, an appliance, or the like.

In various examples, the device 302 may be implemented with one or more baseband processors 306, modems 304, RFICs 312, multiple communications links 310, 336, multiple RFFE buses 330, 332, 334 and/or other types of buses. The device 302 may include other processors, circuits, modules and may be configured for various operations and/or different functionalities. In the example illustrated in FIG. 3, the Modem is coupled to an RF tuner 318 through its RFFE interface 308 and the first RFFE bus 330. The RFIC 312 may include one or more RFFE interfaces 314, 316, controllers, state machines and/or processors that configure and control certain aspects of the RF front-end. The RFIC 312 may communicate with a PA 320 and a power tracking module 322 through a first of its RFFE interfaces 314 and the second RFFE bus 332. The RFIC 312 may communicate with a switch 324 and one or more LNAs 326, 328.

Bus latency can affect the ability of a serial bus to handle high-priority, real-time and/or other time-constrained messages. Low-latency messages, or messages requiring low bus latency, may relate to sensor status, device-generated real-time events and virtualized general-purpose input/output (GPIO). In one example, bus latency may be measured as the time elapsed between a message becoming available for transmission and the delivery of the message or, in some instances, commencement of transmission of the message. Other measures of bus latency may be employed. Bus latency typically includes delays incurred while higher priority messages are transmitted, interrupt processing, the time required to terminate a datagram in process on the serial bus, the time to transmit commands causing bus turnaround between transmit mode and receive mode, bus arbitration and/or command transmissions specified by protocol.

In certain examples, latency-sensitive messages may include coexistence messages. Coexistence messages are transmitted in a multisystem platform to prevent or reduce instances of certain device types impinging on each other, including for example, switches 324, LNAs 326, 328, PAs 320 and other types of device that operate concurrently in a manner that can generate inter-device interference, or that could potentially cause damage to one or more devices. Devices that may interfere with one another may exchange coexistence management (CxM) messages to permit each device to signal imminent actions that may result in interference or conflict. CxM messages may be used to manage operation of shared components including a switch 324, LNA 326, 328, PA 320 and/or an antenna.

Multi-drop interfaces such as RFFE, SPMI, I3C, etc. can reduce the number of physical input/output (I/O) pins used to communicate between multiple devices. Protocols that support communication over a multi-drop serial bus define a datagram structure used to transmit command, control and data payloads. Datagram structures for different protocols define certain common features, including addressing used to select devices to receive or transmit data, clock generation and management, interrupt processing and device priorities. In this disclosure, the example of RFFE protocols may be employed to illustrate certain aspects disclosed herein. However, the concepts disclosed herein are applicable to other serial bus protocols and standards.

In accordance with certain aspects disclosed herein, a one-wire, half-duplex serial bus may be adapted such that one device can communicate digitally and provide power to another device over a single data wire. In one example, the serial bus may be operated in a mode that is compatible or compliant with an I2C, I3C, SPMI and/or RFFE protocol or another protocol. In one example, a bus master may use pulse-amplitude modulation (PAM) to encode data transmitted to one-wire slave devices.

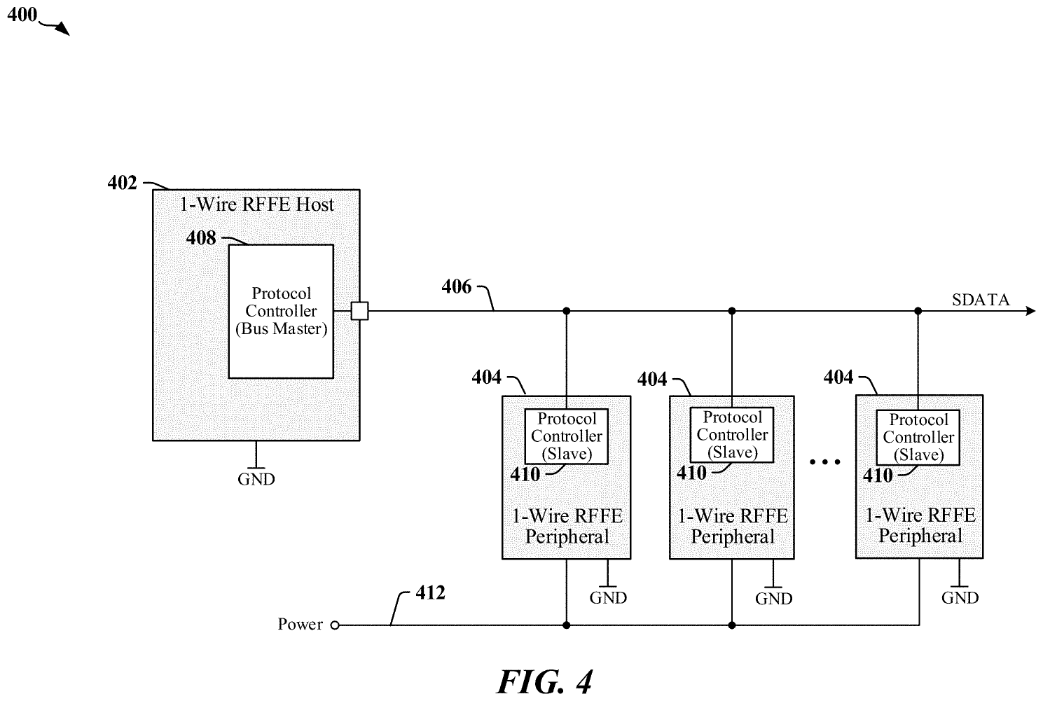

FIG. 4 illustrates a system 400 in which a bus master 402 communicates with one or more one-wire slave devices 404 in accordance with certain aspects disclosed herein. The bus master 402 may be provided in an RFIC, modem, application processor or another type of device. The bus master 402 may be adapted to exchange data with the one-wire slave devices 404 over a single wire, such as the SDATA line 406 in the illustrated system 400. Data can be encoded in a signal transmitted over the SDATA line 406, where the signal includes clock information that can be used by the receiving device to decode data from the signal. Data may be encoded in a PAM signal and/or a pulse-width modulation (PWM) signal when the system 400 is operated in accordance with certain aspects disclosed herein. In the PAM example, a bit value of ‘1’ may be represented as a pulse having a first amplitude and a bit value of ‘0’ may be represented as a pulse having a second amplitude. The first amplitude may be greater than the second amplitude, or the second amplitude may be less than the first amplitude. In the PWM example, a bit value of ‘1’ may be represented as a pulse having a first duration and a bit value of ‘0’ may be represented as a pulse having a second duration. The first duration may be greater than the second duration, or the second duration may be less than the first duration.

In the illustrated example, the bus master 402 and the one-wire slave devices 404 may be operated in general accordance with RFFE protocols, which may be modified to support a 1-Wire mode of communication. Modifications may include the inclusion of a PAM or PWM encoder/decoder. In other examples, the SDATA line 406 may be operated in accordance with another protocol, such as an I2C I3C, SPMI protocol modified to support for the 1-Wire mode of communication.

The bus master 402 and the one-wire slave devices 404 may include or be implemented by respective protocol controllers 408, 410, which may have a processing circuit that includes a processor, controller, state machine or other logic configured to support one or more protocols and/or manage communication over the SDATA line 406. In some implementations, the protocol controller 408 in the bus master 402 may configure one or more one-wire slave devices 404. The protocol controller 408 in the bus master 402 may determine a configuration of a one-wire slave device 404 that is a designated recipient of data to be transmitted over the SDATA line 406, and may encode data in a signal to be transmitted over the SDATA line 406 accordingly.

Each slave device 404 in the illustrated system 400 is coupled to a power supply that includes an active power line 412, and the slave devices 404 and bus master 402 are coupled to a common ground through a substrate or line. Certain aspects disclosed herein enable parasitically-powered slave devices to receive power through the same wire used to exchange data with a different powered device, thereby eliminating at least one pin and at least one interconnect per parasitically-powered slave device.

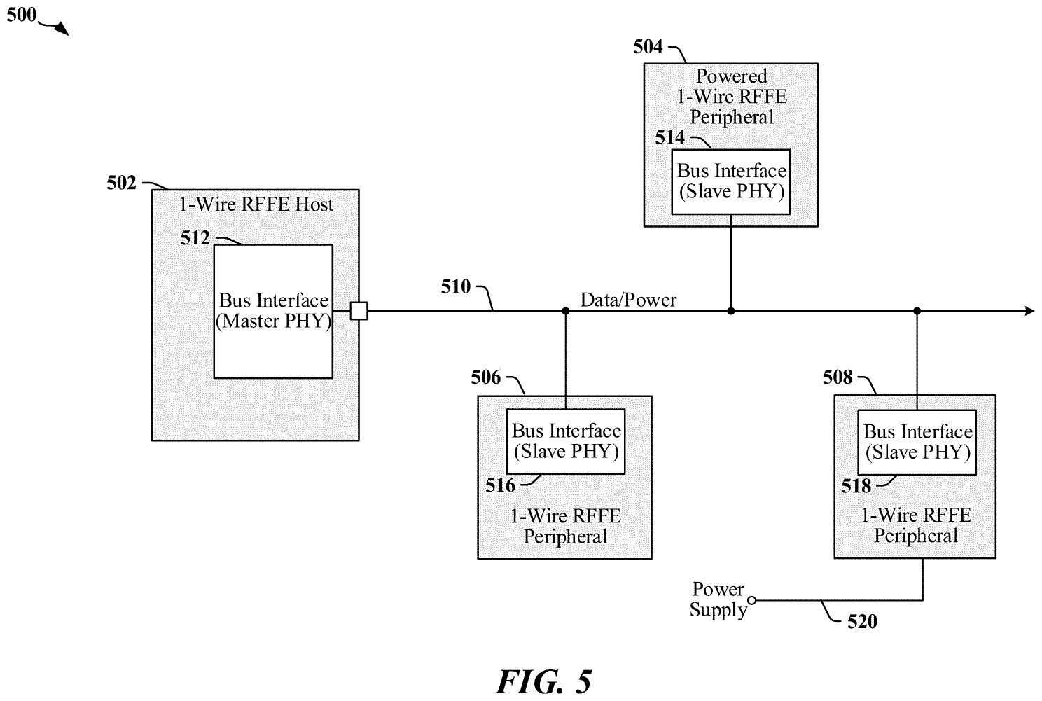

FIG. 5 illustrates a system 500 in which a bus master 502 communicates with one or more parasitically-powered slave devices 504, 506 by extracting power from a data line 510 adapted in accordance with certain aspects disclosed herein. In some implementations, powered slave devices 508 coupled the data line 510 may receive power through a pin coupled to a power supply 520 and may exchange data over the data line 510. In one example, the bus master 502 may be provided in an RFIC, modem, application processor or another type of device. The bus master 502 may be adapted to exchange data with the slave devices 504, 506, 508 over the data line 510 in accordance with a standards-defined or proprietary protocol. In some examples, data can be encoded in a signal transmitted over the data line 510, where the signal includes clock information that can be used by the receiving device to decode data from the signal. Data may be encoded in a PAM signal and/or a pulse-width modulation (PWM) signal when the system 500 is operated in accordance with certain aspects disclosed herein.

In the illustrated example, the bus master 502 and the slave devices 504, 506, 508 can be operated in general accordance with RFFE protocols, which may be modified to support a one-wire mode of communication. Modifications may include the inclusion of a PAM or PWM encoder/decoder. In other examples, the data line 510 may be operated in accordance with another protocol, such as an I2C I3C, SPMI protocol modified to support for the one-wire mode of communication.

The bus master 502 and the one-wire slave devices 504, 506, 508 may include or be implemented by respective protocol controllers 512, 514, 516, 518. The bus master 502 and the one-wire slave devices 504, 506, 508 may have a processing circuit that includes a processor, controller, state machine or other logic configured to support one or more protocols and/or manage communication over the data line 510. In some implementations, the protocol controller 512 in the bus master 502 may configure certain of the slave devices 504, 506, 508. The protocol controller 512 in the bus master 502 may determine a configuration of a one-wire slave device 504, 506, 508 that is a designated recipient of data to be transmitted over the data line 510, and may encode data in a signal to be transmitted over the data line 510 accordingly.

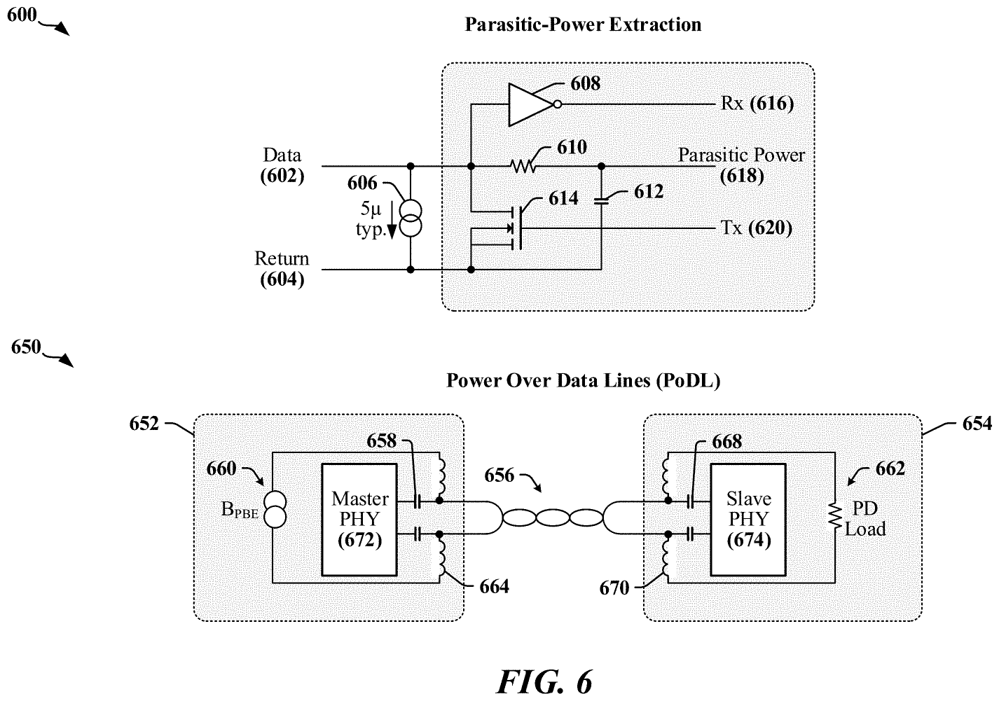

FIG. 6 illustrates an example of a parasitic-power extraction circuit 600 that may be employed by the parasitically-powered slave devices 504, 506 illustrated in FIG. 5. The parasitic-power extraction circuit 600 is coupled to a data line 602 of a one-wire serial bus and a return line 604, where the return line may couple the parasitic-power extraction circuit 600 to a ground plane or the like. The parasitic-power extraction circuit 600 consumes two physical pins or connections and extracts power from the current source 606 provided by drivers in a powered device coupled to the one-wire serial bus. The data lane may be coupled through a load resistance 610 to a capacitor 612 that holds charge used to provide power 618 to the slave device in which the parasitic-power extraction circuit 600 is deployed. A low-power receiver provides a received data signal 616, while a line driver and/or transistor 614 is used to drive the data line 602 responsive to a transit data signal 620.

FIG. 6 illustrates a Power Over Data Lines (PoDL) system 650 that employs an alternative approach to providing power on a two-wire half-duplex data link 656 using two pins in a slave device 654. In this example, a physical layer circuit (PHY 672) in a master device 652 transmits data in a differential signal over the two-wire half-duplex data link 656. Data signals transmitted and received by the master device 652 are decoupled from the direct current (DC) level of the two-wire half-duplex data link 656 through capacitors 658, and data signals received and transmitted by the slave device 654 are decoupled from the direct current (DC) level of the two-wire half-duplex data link 656 through capacitors 668. A power source 660 in the master device 652 is inductively coupled to the two-wire half-duplex data link 656 through inductors 664 and power may be extracted by the slave device 654 from the two-wire half-duplex data link 656 through inductors 670 to drive the load 662 presented by circuits of the slave device 654.

A reduced maximum data rate is typically experienced when the parasitic-power extraction circuit 600 is used. Restrictions on timing may be imposed to limit the duration of time when the data line 602 remains in a low voltage (Logic-0) state, since the charge on the capacitor 612 in the parasitic-power extraction circuit 600 decays at the low-voltage state. The number of parasitic slave devices allowed to extract power from the data line 602 is generally restricted to a maximum number of parasitic slave devices and/or based on individual or cumulative power consumption of the parasitic slave devices. Certain characteristics, limitations and restrictions in conventional systems can render parasitic power harvesting and PoDL techniques unsuitable for applications that are sensitive to timing and power. For example, low-voltage signaling states in transmitted data can limit the power available for parasitic power harvesting and the reactive components used in the PoDL system 650 can may limit data rates and introduce circuit complexity that increases cost of manufacture of low-power slave devices.

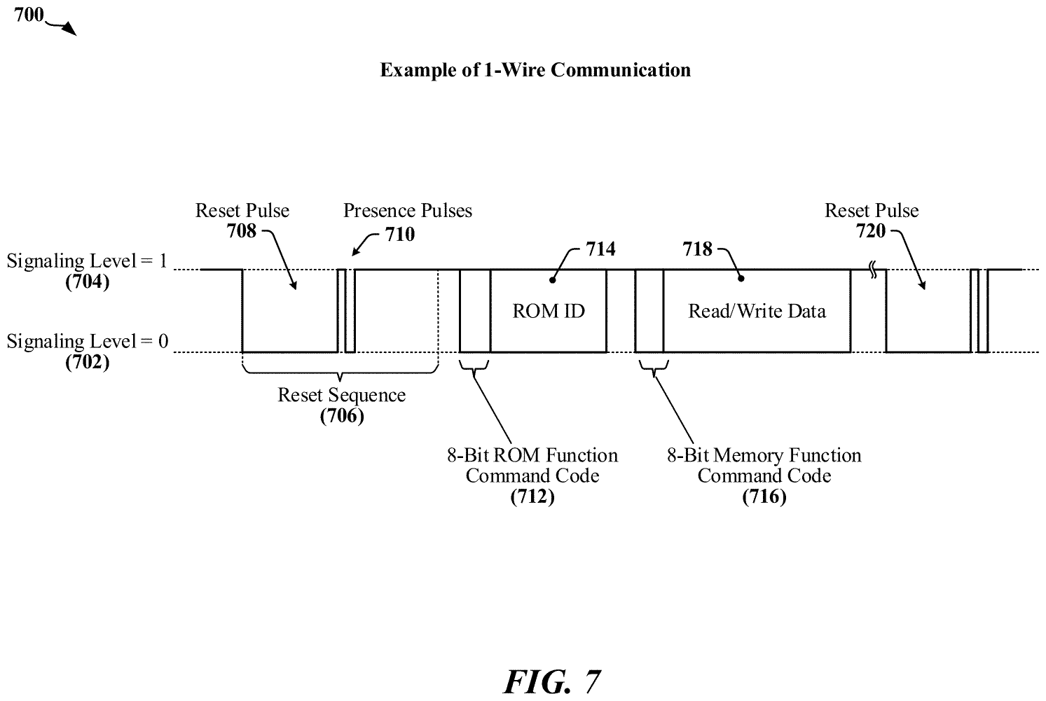

Certain aspects of this disclosure relate to circuits and techniques that enable slave devices to reliably and consistently harvest power from a single-wire serial bus. For example, the effect of low-voltage signaling states on the parasitic-power extraction circuit 600 can be counteracted. FIG. 7 illustrates an example of signaling 700 over a conventional one-wire bus when the parasitic-power extraction circuit 600 is used to power a slave device. The data line 602 may switch between a low signaling level 702 and a high signaling level 704. The half-duplex nature of the single-wire serial bus may necessitate the transmission of initiation and/or turnaround signaling. In one example, a reset sequence 706 is transmitted to quiesce the serial bus and initiate a new transmission. The reset sequence 706 includes a reset pulse 708 and one or more presence pulses 710. The reset sequence 706 may be followed by a command code 712 followed by a unique identifier 714 that selects a device to participate in a transaction. A second command code 716 may be transmitted to indicate a read or write function, where a payload 718 is transmitted after the second command code 716. The transaction is terminated when a second reset pulse 720 is transmitted.

Data may be transmitted in the payload 718 as signaling state or in presence or absence of a pulse. Pulse presence encoding can be used to provide timing information that may otherwise be provided in a clock signal. In some examples, data may be encoded using PWM. In other examples, data may be encoded using PAM.

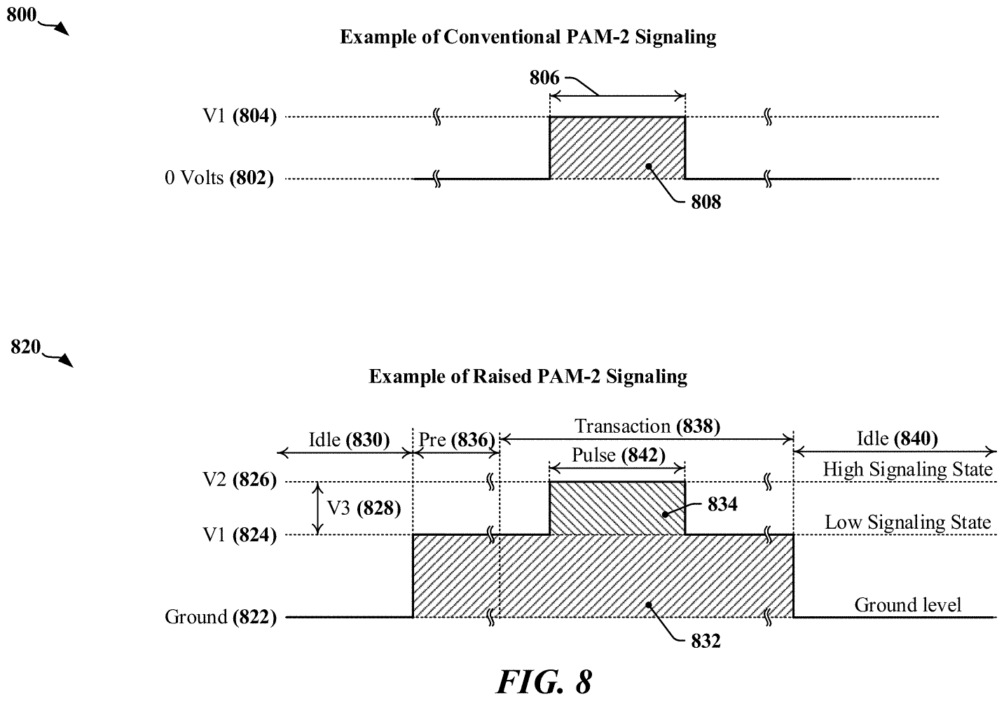

FIG. 8 illustrates a first example of signaling 800 that may be used on a conventional one-wire serial bus when data is encoded using two level PAM (PAM-2) encoding. The first example illustrates the availability of power that can be extracted by a parasitic-power extraction circuit 600. Charge is depleted from the capacitor 612 in the parasitic-power extraction circuit 600 when the data wire is in a low signaling state 802. The capacitor 612 in the parasitic-power extraction circuit 600 can be charged during a pulse 806 when the data wire is in a high signaling state 804. The power that can be harvested by the parasitic-power extraction circuit 600 can be calculated based on the area 808 delineated by the pulse 806.

FIG. 8 illustrates a second example of signaling 820 that may be used on a one-wire serial bus operated in accordance with certain aspects of this disclosure. The signaling 820 relates to non-capacitive coupling and one or more adjustable voltage references for data encoding. In the second example, data is encoded using raised PAM-2 encoding and transmitted in a manner that enables full-time parasitic power extraction. The PAM-2 signaling occurs within a voltage range (V3 828) defined by a low signaling level (V1 824) and a high signaling level (V2 826), where both V1 824 and V2 826 are different from the ground voltage level 822 that is defined for the devices coupled to the serial bus. In the illustrated example, V1 824 and V2 826 are at higher voltage levels than the ground voltage level 822 and V1 824 is at a lower voltage level than V2 826. In some instances, V1 824 is at a higher voltage level than V2 826. In other examples, V1 824 and V2 826 are at lower voltage levels than the ground voltage level 822, where V1 824 is at a different voltage level than V2 826.

Initially, the one-wire serial bus is idle and the data line may be at the ground voltage level 822. In some implementations, the data line may be maintained at V1 824 or V2 826 during idle periods 830, 840 such that one or more slave devices is continuously powered. In the illustrated example, the data line is activated and/or driven to V1 824 before certain types of transactions are to be performed. The data line is maintained at V1 824 for a pre-transaction duration 836 and for the duration 838 of the complete transaction. The data line may enter an idle period 840 at some point after completion of the transaction.

The raised PAM-2 encoding scheme provides a minimum voltage on the data line with respect to the ground voltage level 822 for every encoded data state. In the illustrated signaling 820, the minimum voltage on the data line is V1 824 and a power extraction circuit can continuously extract the power represented by the area 832 under V1 824. The data line may be driven to V1 824 by a high-current driver in the master device, where the high-current driver may be capable of providing sufficient current to enable multiple slave devices to extract the power it needs to operate. When a pulse 842 is transmitted in the raised PAM-2 scheme, additional power that can be harvested by the parasitic-power extraction circuit as represented by the area 834 between V1 824 and V2 826 for the duration of the pulse 806. The power extraction circuit may include a voltage regulation circuit that accommodates the swing in voltage attributable to data transmission. In some implementations, the PAM scheme may encode data in more than two voltage levels. The regulation circuit may deliver a regulated voltage for stable operation when the data line is at a voltage greater than V1 824.

The voltage defined for V1 824 may be referred to as the “PAM Base-Raise voltage,” and V1 824 may be adjustable. In one example, the voltage defined for V1 824 may be selected to meet the typical supply voltage requirement of the devices on the 1-wire bus, and/or to accommodate the number of parasitically-powered slave devices coupled to the one-wire bus. In some instances, the regulation circuit of a parasitically-powered slave device may include a charge pump or other circuit to accommodate a low-voltage V1 824 selections. A charge pump may include a combination of switched capacitors that operates as a voltage converter that can increase or decrease voltage derived parasitically from the data line.

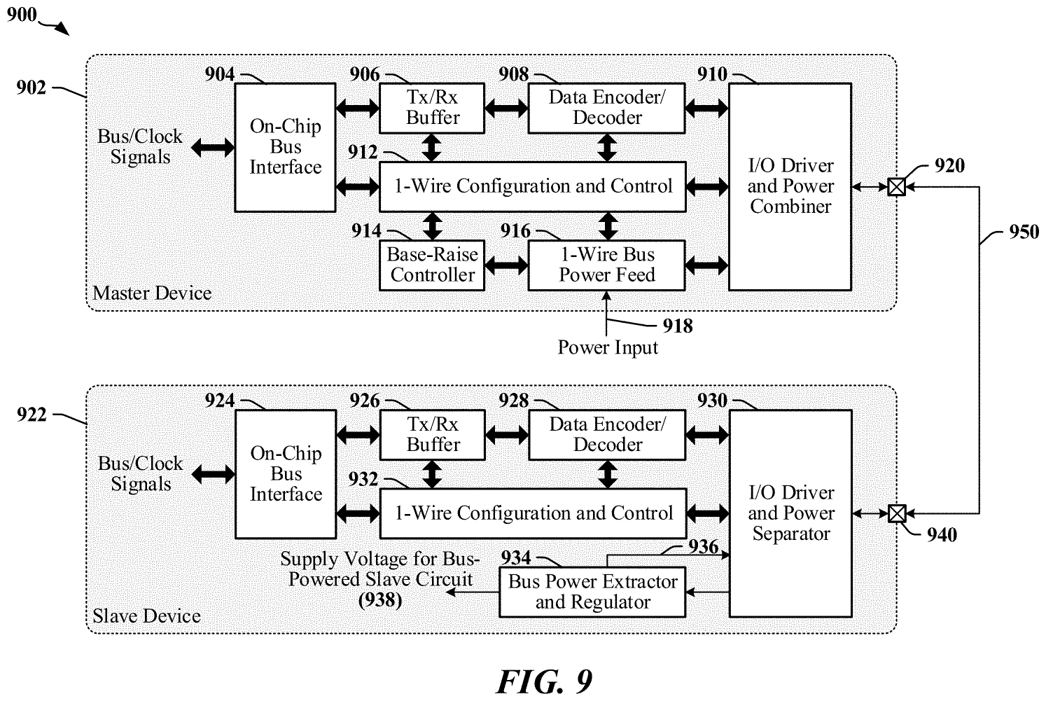

FIG. 9 illustrates a system 900 that uses a single-wire serial bus 950 to couple a bus master device 902 and a slave device 922 through respective pins 920, 940. The bus master device 902 may be coupled to an application processor or other device through a bus interface 904 that receives chip-level bus and clock signals. The bus interface 904 may be coupled to buffer circuits 906 that store and/or aggregate data transferred over the single-wire serial bus 950. The buffer circuits 906 may be coupled to configuration and control circuits 912 that manage a driver circuit 910 coupled to the single-wire serial bus 950, a data encoder/decoder circuit 908 and other components. In certain examples, the data encoder/decoder circuit 908 may be configurable to encode data in accordance with a PAM-2, PAM-4, PWM, pulse-position modulation (PPM), and/or Manchester-encoding schemes. In each of these schemes, data is encoded in signaling that switches within the region defined by between V1 824 and V2 826. In various implementations, the encoders/decoders 908, 928 may be configurable and may flexibly support an arbitrarily selected protocol scheme.

The bus master device 902 may include a base-raise controller 914 that defines and/or maintains the base-raise voltage level (V1 824). The base-raise controller 914 may cooperate with a power manager 916 that receives chip-level power 918 and provides power at the base-raise voltage level. The driver circuit 910 exchanges encoded data signals with the data encoder/decoder circuit 908 and receives power at the base-raise voltage level from the power manager 916 and provides power to the single-wire serial bus 950 while transmitting or receiving data over the single-wire serial bus 950. The configuration and control circuits 912 may configure and manage components related to the operation of the bus interface.

The slave device 922 may be coupled to an application processor or other device through a bus interface 924 that receives chip-level bus and clock signals. In one example, the bus interface 924 is coupled to a controller or sequencing logic that manages a sensor. The bus interface 924 may be coupled to buffer circuits 926 that store and/or aggregate data transferred over the single-wire serial bus 950. The buffer circuits 926 may be coupled to configuration and control circuits 932 that manage a driver circuit 910 coupled to the single-wire serial bus 950, a data encoder/decoder circuit 928 and/or other components. In certain examples, the data encoder/decoder circuit 928 may be configurable to encode data in accordance with a PAM-2 scheme, PAM-4 scheme and/or one or more PW schemes. The slave device 922 may include a parasitic power extractor circuit 934. The parasitic power extractor circuit 934 may include a voltage regulator that controls voltage of power supply 936, 938 provided to one or more components of the slave device 922. A driver circuit 930 exchanges encoded data signals with the data encoder/decoder circuit 908 and may provide the received signal and/or a charge derived from the received signal to the parasitic power extractor circuit 934 while data is being transmitted or received over the single-wire serial bus 950. The configuration and control circuits 932 may configure and manage components related to the operation of the bus interface.

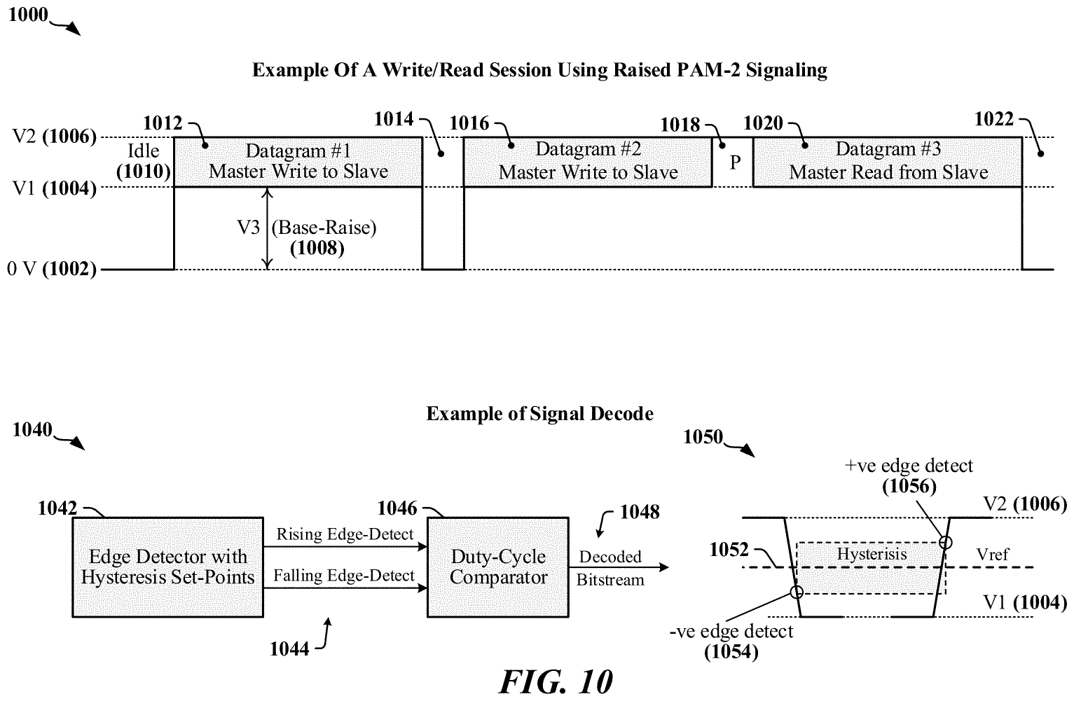

FIG. 10 illustrates an example of multi-transactional signaling 1000 on a one-wire serial bus coupled to at least one slave device that extracts power parasitically from the data line. In this example, data is encoded using raised PAM-2 encoding and transmitted in a manner that enables parasitic power extraction regardless of encoded data values. The PAM-2 signaling occurs between a low signaling level (V1 1004) and a high signaling level (V2 1006), where both V1 1004 and V2 1006 are different from the ground voltage level 1002 that is defined for the devices coupled to the serial bus. Here, V1 1004 and V2 1006 are at higher voltage levels than the ground voltage level 1002 and V1 1004 is at a lower voltage level than V2 1006.

The multi-transactional signaling 1000 corresponds to the transmission of three datagrams 1012, 1016, 1020. Two write datagrams 1012, 1016 may be directed to one or more slave devices and a read datagram 1020 may be received from one or more slave devices. In this example, a pre-transactional drive period 1018 is provided prior to the transaction involving the read datagram 1020 to ensure that the data line is driven to V1 1004, which enables power extraction at the base-raise voltage level 1008 for operating drivers in the receiving slave devices. The data line may be at the ground voltage level 1002 during idle periods 1010, 1014 preceding transactions corresponding to the write datagrams 1012, 1016 and/or during an idle period 1022 after completion of all datagrams 1012, 1016, 1020.

FIG. 10 also illustrates an example of signal decoding that employs edge-triggered data recovery logic 1040 that operates in accordance with the timing of the illustrated signaling 1050. In one example, the edge-triggered data recovery logic 1040 can be provided in the encoders/decoders 908, 928 illustrated in FIG. 9. The use of edge-triggered data recovery logic 1040 can alleviate issues associated with the small-signal amplitude available for digital encoding within the voltage range defined by V1 1004 and V2 1006. In one example of a raised-PAM implementation for mobile-systems applications, voltage levels could be defined as: V1=1.2 volts, V2=1.8 volts, V3=V2−V1=0.6 volts. In this latter example, slave devices may harvest power at 1.2 volts and decode data switching within a 0.6 volt range. At higher frequencies, it can be difficult to operate a decoder that relies on amplitude detection.

In certain implementations, the edge-triggered data recovery logic 1040 includes an edge detector 1042 with configurable hysteresis set points. For example, a reference voltage level 1052 may be defined at a mid-point between V1 1004 and V2 1006 and a hysteresis point 1054 for detecting falling edges may be set below the reference voltage level 1052, while a hysteresis point 1056 for detecting rising edges may be set above the reference voltage level 1052. The edge detector 1042 provides independent edge detection signals 1044 that indicate occurrence of rising or falling edges. The independent edge detection signals may be used by decoding logic to determine presence and/or width of a pulse. In the illustrated example, a duty-cycle comparator 1046 may be used to decode data from a received low-amplitude signal, where the duty-cycle comparator 1046 is triggered by edge detection signals. The duty-cycle comparator 1046 may provide a decoded bitstream 1048.

Examples of Processing Circuits and Methods

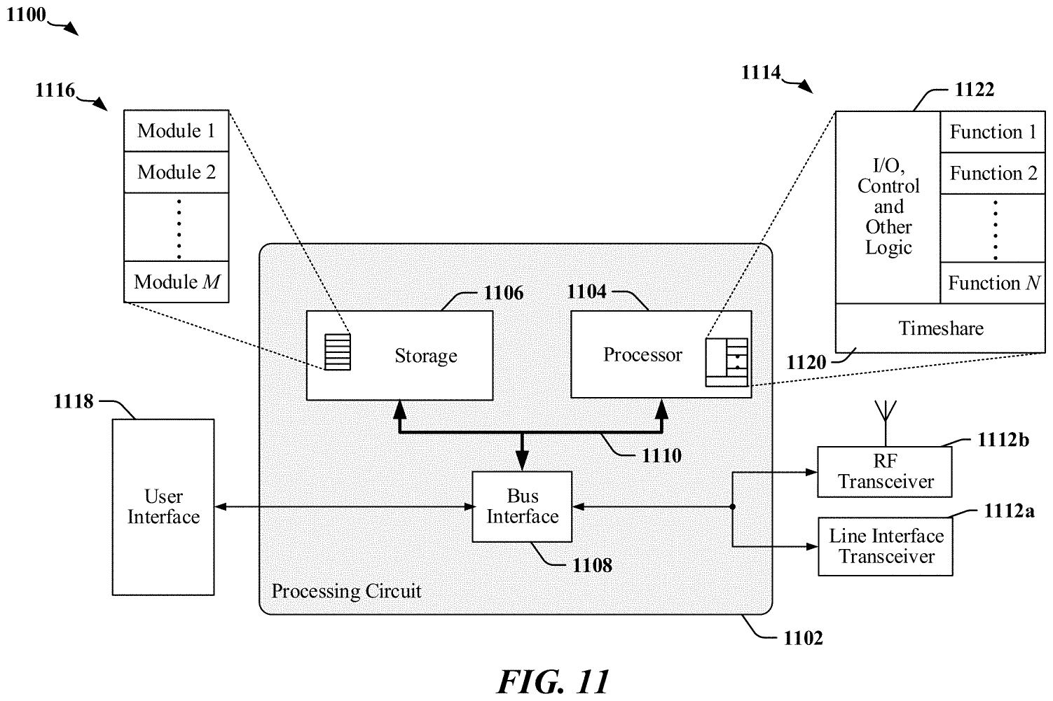

FIG. 11 is a diagram illustrating an example of a hardware implementation for an apparatus 1100. In some examples, the apparatus 1100 may perform one or more functions disclosed herein. In accordance with various aspects of the disclosure, an element, or any portion of an element, or any combination of elements as disclosed herein may be implemented using a processing circuit 1102. The processing circuit 1102 may include one or more processors 1104 that are controlled by some combination of hardware and software modules. Examples of processors 1104 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1104 may include specialized processors that perform specific functions, and that may be configured, augmented or controlled by one of the software modules 1116. The one or more processors 1104 may be configured through a combination of software modules 1116 loaded during initialization, and further configured by loading or unloading one or more software modules 1116 during operation.

In the illustrated example, the processing circuit 1102 may be implemented with a bus architecture, represented generally by the bus 1110. The bus 1110 may include any number of interconnecting buses and bridges depending on the specific application of the processing circuit 1102 and the overall design constraints. The bus 1110 links together various circuits including the one or more processors 1104, and storage 1106. Storage 1106 may include memory devices and mass storage devices, and may be referred to herein as computer-readable media and/or processor-readable media. The bus 1110 may also link various other circuits such as timing sources, timers, peripherals, voltage regulators, and power management circuits. A bus interface 1108 may provide an interface between the bus 1110 and one or more transceivers 1112a, 1112b. A transceiver 1112a, 1112b may be provided for each networking technology supported by the processing circuit. In some instances, multiple networking technologies may share some or all of the circuitry or processing modules found in a transceiver 1112a, 1112b. Each transceiver 1112a, 1112b provides a means for communicating with various other apparatus over a transmission medium. In one example, a transceiver 1112a may be used to couple the apparatus 1100 to a multi-wire bus. In another example, a transceiver 1112b may be used to connect the apparatus 1100 to a radio access network. Depending upon the nature of the apparatus 1100, a user interface 1118 (e.g., keypad, display, speaker, microphone, joystick) may also be provided, and may be communicatively coupled to the bus 1110 directly or through the bus interface 1108.

A processor 1104 may be responsible for managing the bus 1110 and for general processing that may include the execution of software stored in a computer-readable medium that may include the storage 1106. In this respect, the processing circuit 1102, including the processor 1104, may be used to implement any of the methods, functions and techniques disclosed herein. The storage 1106 may be used for storing data that is manipulated by the processor 1104 when executing software, and the software may be configured to implement any one of the methods disclosed herein.

One or more processors 1104 in the processing circuit 1102 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1106 or in an external computer-readable medium. The external computer-readable medium and/or storage 1106 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1106 may also include, by way of example, a carrier wave, a transmission line, and any other suitable medium for transmitting software and/or instructions that may be accessed and read by a computer. Computer-readable medium and/or the storage 1106 may reside in the processing circuit 1102, in the processor 1104, external to the processing circuit 1102, or be distributed across multiple entities including the processing circuit 1102. The computer-readable medium and/or storage 1106 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1106 may maintain software maintained and/or organized in loadable code segments, modules, applications, programs, etc., which may be referred to herein as software modules 1116. Each of the software modules 1116 may include instructions and data that, when installed or loaded on the processing circuit 1102 and executed by the one or more processors 1104, contribute to a run-time image 1114 that controls the operation of the one or more processors 1104. When executed, certain instructions may cause the processing circuit 1102 to perform functions in accordance with certain methods, algorithms and processes described herein.

Some of the software modules 1116 may be loaded during initialization of the processing circuit 1102, and these software modules 1116 may configure the processing circuit 1102 to enable performance of the various functions disclosed herein. For example, some software modules 1116 may configure internal devices and/or logic circuits 1122 of the processor 1104, and may manage access to external devices such as a transceiver 1112a, 1112b, the bus interface 1108, the user interface 1118, timers, mathematical coprocessors, and so on. The software modules 1116 may include a control program and/or an operating system that interacts with interrupt handlers and device drivers, and that controls access to various resources provided by the processing circuit 1102. The resources may include memory, processing time, access to a transceiver 1112a, 1112b, the user interface 1118, and so on.

One or more processors 1104 of the processing circuit 1102 may be multifunctional, whereby some of the software modules 1116 are loaded and configured to perform different functions or different instances of the same function. The one or more processors 1104 may additionally be adapted to manage background tasks initiated in response to inputs from the user interface 1118, the transceiver 1112a, 1112b, and device drivers, for example. To support the performance of multiple functions, the one or more processors 1104 may be configured to provide a multitasking environment, whereby each of a plurality of functions is implemented as a set of tasks serviced by the one or more processors 1104 as needed or desired. In one example, the multitasking environment may be implemented using a timesharing program 1120 that passes control of a processor 1104 between different tasks, whereby each task returns control of the one or more processors 1104 to the timesharing program 1120 upon completion of any outstanding operations and/or in response to an input such as an interrupt. When a task has control of the one or more processors 1104, the processing circuit is effectively specialized for the purposes addressed by the function associated with the controlling task. The timesharing program 1120 may include an operating system, a main loop that transfers control on a round-robin basis, a function that allocates control of the one or more processors 1104 in accordance with a prioritization of the functions, and/or an interrupt driven main loop that responds to external events by providing control of the one or more processors 1104 to a handling function.

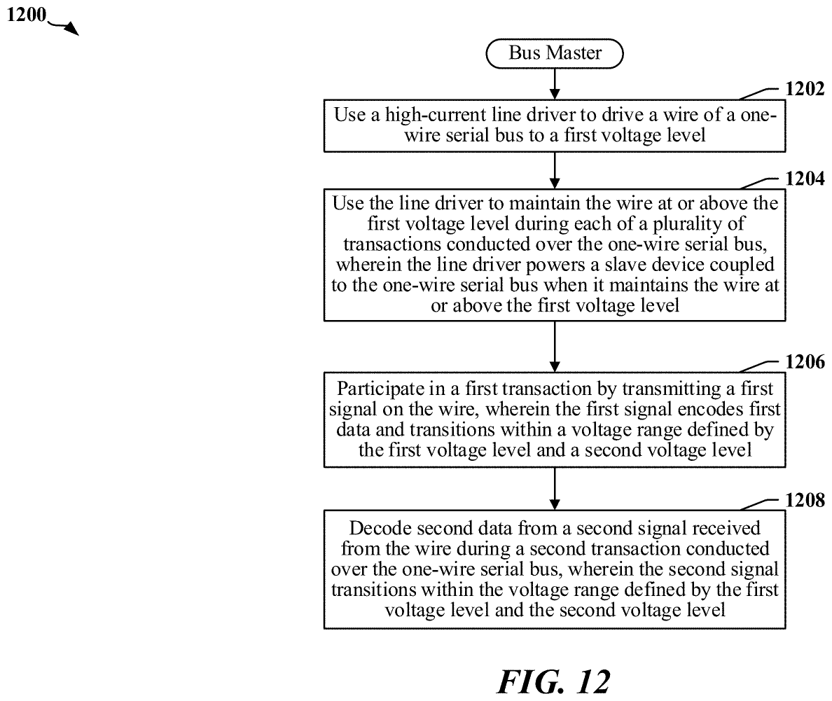

FIG. 12 is a flowchart 1200 of a method that may be performed by a device coupled to a serial bus. In one example, the method is performed by a bus master device. One or more one-wire slave devices may be coupled to the serial bus.

At block 1202, the device may use a line driver to drive a wire of a one-wire serial bus to a first voltage level. At block 1204, the device may use the line driver to maintain the wire at or above the first voltage level for the duration of each of a plurality of transactions conducted over the one-wire serial bus. The line driver may power a slave device coupled to the one-wire serial bus when it maintains the wire at or above the first voltage level. At block 1206, the device may participate in a first transaction by transmitting a first signal on the wire. The first signal may encode first data and transitions within a voltage range defined by the first voltage level and a second voltage level. At block 1208, the device may decode second data from a second signal received from the wire during a second transaction conducted over the one-wire serial bus. The second signal may transition within the voltage range defined by the first voltage level and the second voltage level.

In some instances, the wire is driven by the line driver to the first voltage level during an idle period and before the second transaction commences. Driving the wire to the first voltage level may enable the slave device to generate power before the second transaction commences. The line driver may begin driving the wire at a time indicated by a protocol controller or based on configuration information provided in the serial bus interface of the master device. Data may be transmitted in formats defined or compatible with an I2C, I3C, SPMI and/or RFFE protocol.

In various implementations, the wire is at a ground voltage defined for the master device before the first transaction commences. A bus idle period may be in effect when the wire is at the ground voltage. In some instances, ground voltage may be a zero-volt level defined for the master device, the slave device and/or an IC associated with the master device or the slave device. In one example, the first voltage level and the second voltage level are positive with respect to the ground voltage, where the second voltage has a higher voltage level than the first voltage. In another example, the first voltage level and the second voltage level are negative with respect to the ground voltage, where the second voltage has a lower voltage level than the first voltage. The first data and/or the second data may be encoded using PAM, PWM, PPM or Manchester-encoding. The first signal and/or the second signal may transition between multiple voltage levels within the voltage range defined by the first voltage level and a second voltage level, including when a PAM-4, PAM-8 or Manchester-encoding scheme is used to encode data.

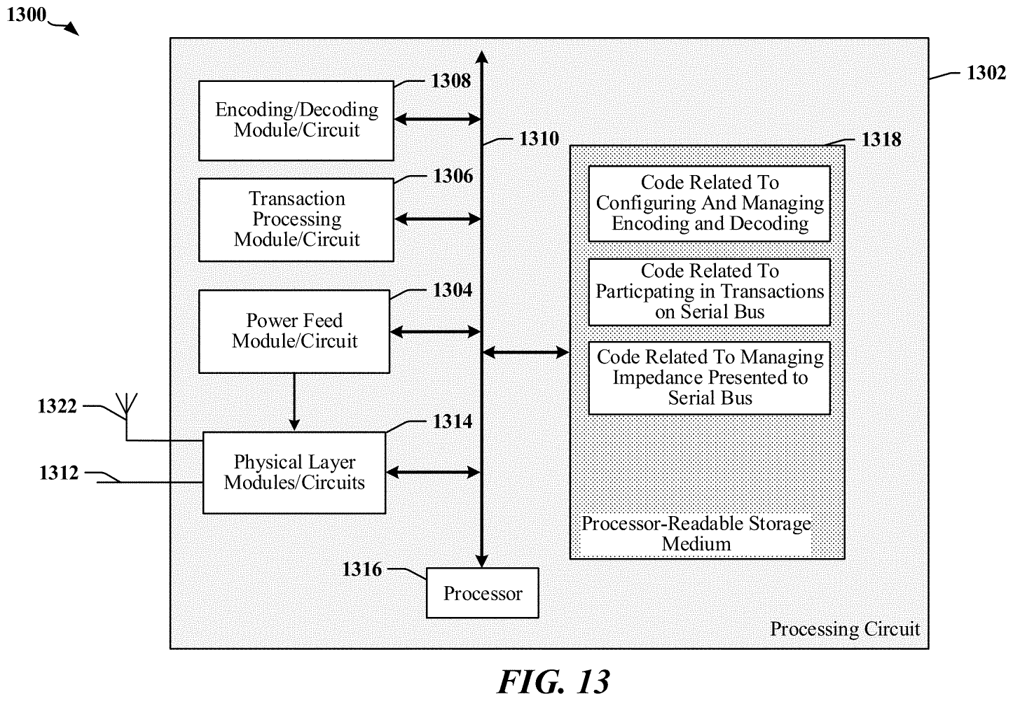

FIG. 13 is a diagram illustrating a simplified example of a hardware implementation for an apparatus 1300 employing a processing circuit 1302. The processing circuit typically has a controller or processor 1316 that may include one or more microprocessors, microcontrollers, digital signal processors, sequencers and/or state machines. The processing circuit 1302 may be implemented with a bus architecture, represented generally by the bus 1310. The bus 1310 may include any number of interconnecting buses and bridges depending on the specific application of the processing circuit 1302 and the overall design constraints. The bus 1310 links together various circuits including one or more processors and/or hardware modules, represented by the controller or processor 1316, the modules or circuits 1304, 1306 and 1308 and the processor-readable storage medium 1318. One or more physical layer circuits and/or modules 1314 may be provided to support communications over a communication link implemented using a one-wire serial bus 1312, through an antenna or antenna array 1322 (to a radio access network for example), and so on. The bus 1310 may also link various other circuits such as timing sources, peripherals, power-supplies, voltage regulators, and power management circuits, which are well known in the art, and therefore, will not be described any further.

The processor 1316 is responsible for general processing, including the execution of software, code and/or instructions stored on the processor-readable storage medium 1318. The processor-readable storage medium may include a non-transitory storage medium. The software, when executed by the processor 1316, causes the processing circuit 1302 to perform the various functions described supra for any particular apparatus. The processor-readable storage medium may be used for storing data that is manipulated by the processor 1316 when executing software. The processing circuit 1302 further includes at least one of the modules 1304, 1306 and 1308. The modules 1304, 1306 and 1308 may be software modules running in the processor 1316, resident/stored in the processor-readable storage medium 1318, one or more hardware modules coupled to the processor 1316, or some combination thereof. The modules 1304, 1306 and 1308 may include microcontroller instructions, state machine configuration parameters, or some combination thereof.

In one configuration, the apparatus 1300 includes modules and/or circuits 1304 adapted to feed power onto the one-wire serial bus 1312, modules and/or circuits 1306 adapted to manage transactions that may include write and/or read transactions that involve transmission of datagrams, and modules and/or circuits 1308 adapted to encode and decode data in signals transmitted over the one-wire serial bus 1312. In one example, a signal may be provided to a line driver with a power feed for transmission during a write transaction.

In one example, the apparatus 1300 includes physical layer circuits and/or modules 1314 that implement an interface circuit with a line driver adapted to couple the apparatus 1300 to a serial bus. The physical layer circuits and/or modules 1314 may have a line driver coupled to a wire of a one-wire serial bus and configured to power one or more slave devices coupled to the one-wire serial bus. The apparatus 1300 may have a coding circuit configured to encode and decode data in one or more signals transmitted over the one-wire serial bus, and the controller or processor 1316 may be configured to cause the line driver to drive the wire to a first voltage level, cause the line driver to maintain the wire at or above the first voltage level for the duration of each of a plurality of transactions conducted over the wire, participate in a first transaction by causing the line driver to transmit a first signal provided by the coding circuit and encodes first data, and cause the coding circuit to decode second data from a second signal received from the wire during a second transaction. The line driver may power the one or more slave devices when it maintains the wire at or above the first voltage level. The first signal and/or the second signal may transition within a voltage range defined by the first voltage level and a second voltage level.

In some instances, controller or processor 1316 may be configured to cause the line driver to drive the wire to the first voltage level during an idle period and before the second transaction commences. Driving the wire to the first voltage level may enable the slave device to generate power before the second transaction commences. The line driver may be caused to begin driving the wire at a time indicated by a protocol controller or based on configuration information provided in the serial bus interface of the master device.

In various implementations, the wire is at a ground voltage defined for the master device before the first transaction commences. A bus idle period may be in effect when the wire is at the ground voltage. In some instances, ground voltage may be a zero-volt level defined for the master device, the slave device and/or an IC associated with the master device or the slave device. In one example, the first voltage level and the second voltage level are positive with respect to the ground voltage, where the second voltage has a higher voltage level than the first voltage. In another example, the first voltage level and the second voltage level are negative with respect to the ground voltage, where the second voltage has a lower voltage level than the first voltage. The first data and/or the second data may be encoded using PAM, PWM, PPM or Manchester-encoding. The first signal and/or the second signal may transition between multiple voltage levels within the voltage range defined by the first voltage level and a second voltage level, including when a PAM-4, PAM-8 or Manchester-encoding scheme is used to encode data.

The processor-readable storage medium 1318 may include transitory or non-transitory storage devices configured to store code, instructions and/or parameters used to implement one or more methods or procedures disclosed herein. The processor-readable storage medium 1318 may include code for using a line driver to drive a wire of a one-wire serial bus to a first voltage level, using the line driver to maintain the wire at or above the first voltage level for the duration of each of a plurality of transactions conducted over the one-wire serial bus, participating in a first transaction by transmitting a first signal on the wire, and decoding second data from a second signal received from the wire during a second transaction conducted over the one-wire serial bus. The line driver can power a slave device coupled to the one-wire serial bus when it maintains the wire at or above the first voltage level. The first signal can encode first data and transitions within a voltage range defined by the first voltage level and a second voltage level. The second signal may transition within the voltage range defined by the first voltage level and the second voltage level.

In some instances, the wire is driven by the line driver to the first voltage level during an idle period and before the second transaction commences. Driving the wire to the first voltage level may enable the slave device to generate power before the second transaction commences. The line driver may begin driving the wire at a time indicated by a protocol controller or based on configuration information provided in the serial bus interface of the master device.

In various implementations, the wire is at a ground voltage defined for the master device before the first transaction commences. A bus idle period may be in effect when the wire is at the ground voltage. In some instances, ground voltage may be a zero-volt level defined for the master device, the slave device and/or an IC associated with the master device or the slave device. In one example, the first voltage level and the second voltage level are positive with respect to the ground voltage, where the second voltage has a higher voltage level than the first voltage. In another example, the first voltage level and the second voltage level are negative with respect to the ground voltage, where the second voltage has a lower voltage level than the first voltage. The first data and/or the second data may be encoded using PAM, PWM, PPM or Manchester-encoding. The first signal and/or the second signal may transition between multiple voltage levels within the voltage range defined by the first voltage level and a second voltage level, including when a PAM-4, PAM-8 or Manchester-encoding scheme is used to encode data.

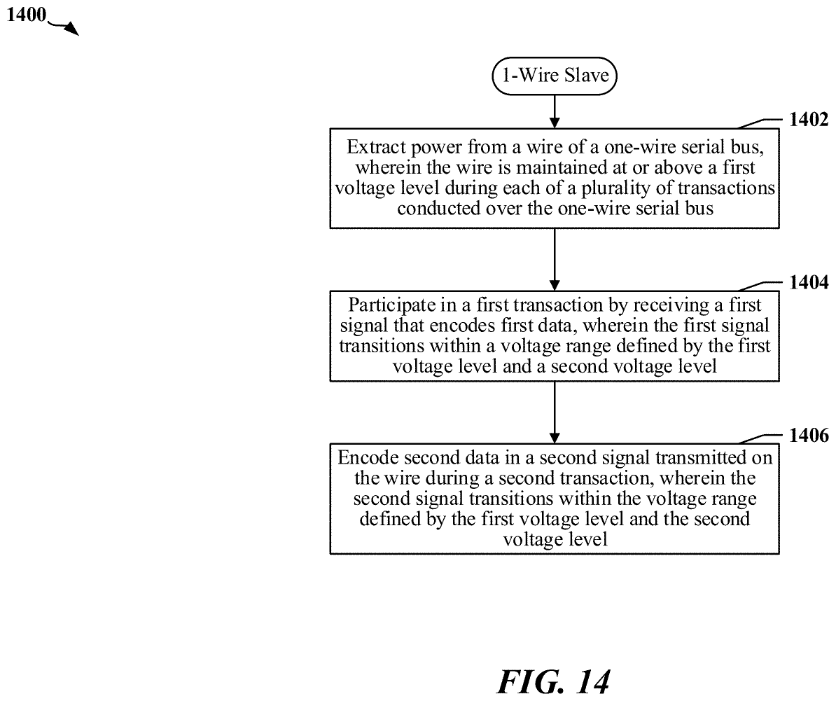

FIG. 14 is a flowchart 1400 of a method that may be performed by a one-wire slave device coupled to a serial bus. At least one bus master is coupled to the serial bus. One or more one-wire other slave devices may be coupled to the serial bus.

At block 1402, the one-wire slave device may extract power from a wire of a one-wire serial bus. The wire may be maintained at or above a first voltage level for the duration of each of a plurality of transactions conducted over the one-wire serial bus. At block 1404, the one-wire slave device may participate in a first transaction by receiving a first signal that encodes first data. The first signal may transition within a voltage range defined by the first voltage level and a second voltage level. At block 1406, the one-wire slave device may encode second data in a second signal transmitted on the wire during a second transaction. The second signal may transition within the voltage range defined by the first voltage level and the second voltage level. Data may be transmitted in formats defined or compatible with an I2C, I3C, SPMI and/or RFFE protocol.

In one example, the wire is driven by a master device to the first voltage level during an idle period and before the second transaction commences. The master device may continue driving the wire while the second signal is transmitted. The wire may be at a ground voltage defined for the slave device before the first transaction commences. In another example, the first voltage level and the second voltage level may be positive with respect to the ground voltage. In another example, the first voltage level and the second voltage level may be negative with respect to the ground voltage. In some instances, ground voltage may be a zero-volt level defined for the master device, the slave device and/or an IC associated with the master device or the slave device. In one example, the first voltage level and the second voltage level are positive with respect to the ground voltage, where the second voltage has a higher voltage level than the first voltage. In another example, the first voltage level and the second voltage level are negative with respect to the ground voltage, where the second voltage has a lower voltage level than the first voltage. The first data and/or the second data may be encoded using PAM, PWM, PPM or Manchester-encoding. The first signal and/or the second signal may transition between multiple voltage levels within the voltage range defined by the first voltage level and a second voltage level, including when a PAM-4, PAM-8 or Manchester-encoding scheme is used to encode data.

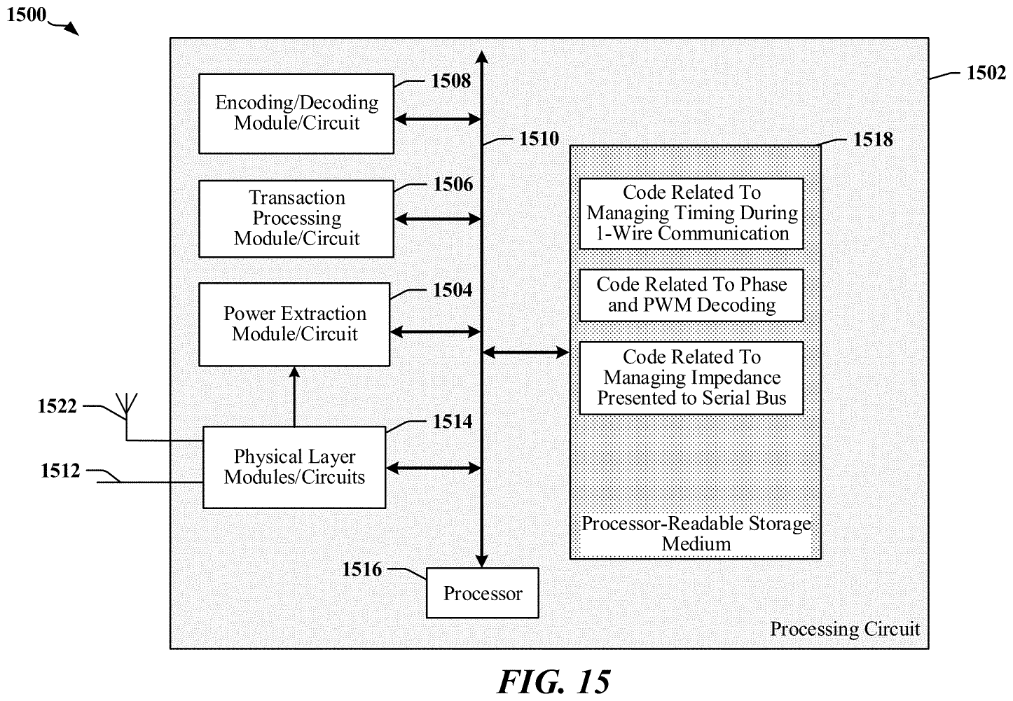

FIG. 15 is a diagram illustrating a simplified example of a hardware implementation for an apparatus 1500 employing a processing circuit 1502. The processing circuit typically has a controller or processor 1516 that may include one or more microprocessors, microcontrollers, digital signal processors, sequencers and/or state machines. The processing circuit 1502 may be implemented with a bus architecture, represented generally by the bus 1510. The bus 1510 may include any number of interconnecting buses and bridges depending on the specific application of the processing circuit 1502 and the overall design constraints. The bus 1510 links together various circuits including one or more processors and/or hardware modules, represented by the controller or processor 1516, the modules or circuits 1504, 1506 and 1508 and the processor-readable storage medium 1518. One or more physical layer circuits and/or modules 1514 may be provided to support communications over a communication link implemented using a one-wire serial bus 1512, through an antenna or antenna array 1522 (to a radio access network for example), and so on. The bus 1510 may also link various other circuits such as timing sources, peripherals, voltage regulators, and power management circuits, which are well known in the art, and therefore, will not be described any further.

The processor 1516 is responsible for general processing, including the execution of software, code and/or instructions stored on the processor-readable storage medium 1518. The processor-readable storage medium may include a non-transitory storage medium. The software, when executed by the processor 1516, causes the processing circuit 1502 to perform the various functions described supra for any particular apparatus. The processor-readable storage medium may be used for storing data that is manipulated by the processor 1516 when executing software. The processing circuit 1502 further includes at least one of the modules 1504, 1506 and 1508. The modules 1504, 1506 and 1508 may be software modules running in the processor 1516, resident/stored in the processor-readable storage medium 1518, one or more hardware modules coupled to the processor 1516, or some combination thereof. The modules 1504, 1506 and 1508 may include microcontroller instructions, state machine configuration parameters, or some combination thereof.

In one configuration, the apparatus 1500 includes modules and/or circuits 1504 adapted to extract power from a wire of the one-wire serial bus 1512, modules and/or circuits 1506 adapted to manage transactions conducted over the one-wire serial bus 1512, and modules and/or circuits 1508 adapted to encode or decode data from signals received during the transactions conducted over the one-wire serial bus 1512. Data may be encoded in formats defined or compatible with an I2C, I3C, SPMI and/or RFFE protocol.

In one example, the apparatus 1500 includes physical layer circuits and/or modules 1514 that implement an interface circuit with a line driver adapted to couple the apparatus 1500 to a serial bus. The apparatus 1500 may have a power circuit coupled to a wire of the one-wire serial bus 1512 and configured to extract power from the wire when the wire is actively driven by another device. The wire may be maintained at or above a first voltage level for the duration of each of a plurality of transactions conducted over the one-wire serial bus. The apparatus 1500 may have a coding circuit configured to encode and decode data in one or more signals transmitted over the one-wire serial bus 1512. The controller or processor 1516 may be configured to participate in a first transaction by causing the coding circuit to decode data from a first signal received from the wire, and participate in a second transaction by causing the coding circuit to encode second data in a second signal transmitted on the wire. The first signal and/or the second signal may transition within a voltage range defined by the first voltage level and a second voltage level.

In some instances, the wire is driven by the master device to the first voltage level during an idle period and before the second transaction commences, and the master device continues driving the wire while the second signal is transmitted.

The wire may be at a ground voltage defined for the slave device before the first transaction commences. In another example, the first voltage level and the second voltage level may be positive with respect to the ground voltage. In another example, the first voltage level and the second voltage level may be negative with respect to the ground voltage. In some instances, ground voltage may be a zero-volt level defined for the master device, the slave device and/or an IC associated with the master device or the slave device. In one example, the first voltage level and the second voltage level are positive with respect to the ground voltage, where the second voltage has a higher voltage level than the first voltage. In another example, the first voltage level and the second voltage level are negative with respect to the ground voltage, where the second voltage has a lower voltage level than the first voltage. The first data and/or the second data may be encoded using PAM, PWM, PPM or Manchester-encoding. The first signal and/or the second signal may transition between multiple voltage levels within the voltage range defined by the first voltage level and a second voltage level, including when a PAM-4, PAM-8 or Manchester-encoding scheme is used to encode data.

The processor-readable storage medium 1518 may include transitory or non-transitory storage devices configured to store code, instructions and/or parameters used to implement one or more methods or procedures disclosed herein. The processor-readable storage medium 1518 may include code for extracting power from a wire of a one-wire serial bus, participating in a first transaction by receiving a first signal that encodes first data, and encoding second data in a second signal transmitted on the wire during a second transaction. The wire may be maintained at or above a first voltage level for the duration of each of a plurality of transactions conducted over the one-wire serial bus. The first signal and/or the second signal may transition within a voltage range defined by the first voltage level and a second voltage level. Data may be transmitted in formats defined or compatible with an I2C, I3C, SPMI and/or RFFE protocol.

In one example, the wire is driven by a master device to the first voltage level during an idle period and before the second transaction commences. The master device may continue driving the wire while the second signal is transmitted. The wire may be at a ground voltage defined for the slave device before the first transaction commences. In another example, the first voltage level and the second voltage level may be positive with respect to the ground voltage. In another example, the first voltage level and the second voltage level may be negative with respect to the ground voltage. In some instances, ground voltage may be a zero-volt level defined for the master device, the slave device and/or an IC associated with the master device or the slave device. In one example, the first voltage level and the second voltage level are positive with respect to the ground voltage, where the second voltage has a higher voltage level than the first voltage. In another example, the first voltage level and the second voltage level are negative with respect to the ground voltage, where the second voltage has a lower voltage level than the first voltage. The first data and/or the second data may be encoded using PAM, PWM, PPM or Manchester-encoding. The first signal and/or the second signal may transition between multiple voltage levels within the voltage range defined by the first voltage level and a second voltage level, including when a PAM-4, PAM-8 or Manchester-encoding scheme is used to encode data.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A method of data communication at a master device, comprising:
using a line driver to drive a wire of a one-wire serial bus to a first voltage level;
using the line driver to maintain the wire at or above the first voltage level during each of a plurality of transactions conducted over the one-wire serial bus, wherein the line driver powers a slave device coupled to the one-wire serial bus when it maintains the wire at or above the first voltage level;
participating in a first transaction by transmitting a first signal on the wire, wherein the first signal encodes first data and transitions within a voltage range defined by the first voltage level and a second voltage level; and
decoding second data from a second signal received from the wire during a second transaction conducted over the one-wire serial bus, wherein the second signal transitions within the voltage range defined by the first voltage level and the second voltage level.

2. The method of claim 1, wherein the wire is driven by the line driver to the first voltage level during an idle period and before the second transaction commences.

3. The method of claim 1, wherein the wire is at a ground voltage defined for the master device before the first transaction commences.

4. The method of claim 3, wherein the first voltage level and the second voltage level are positive with respect to the ground voltage.

5. The method of claim 3, wherein the first voltage level and the second voltage level are negative with respect to the ground voltage.

6. The method of claim 1, wherein the first data is encoded using pulse amplitude modulation.

7. The method of claim 1, wherein the first data is encoded using pulse width modulation.

8. The method of claim 1, wherein the second signal is transmitted using pulse position modulation.

9. A data communication apparatus configured to operate as a master device, comprising:
a line driver coupled to a wire of a one-wire serial bus and configured to power one or more slave devices coupled to the one-wire serial bus;
a coding circuit configured to encode and decode data in one or more signals transmitted over the one-wire serial bus; and
a controller configured to:
cause the line driver to drive the wire to a first voltage level;
cause the line driver to maintain the wire at or above the first voltage level during each of a plurality of transactions conducted over the one-wire serial bus, wherein the line driver powers the one or more slave devices when it maintains the wire at or above the first voltage level;
participate in a first transaction by causing the line driver to transmit a first signal provided by the coding circuit that encodes first data, wherein the first signal transitions within a voltage range defined by the first voltage level and a second voltage level; and
causing the coding circuit to decode second data from a second signal received from the wire during a second transaction, wherein the second signal transitions within the voltage range defined by the first voltage level and the second voltage level.

10. The data communication apparatus of claim 9, wherein the controller is further configured to:
cause the line driver to drive the wire to the first voltage level during an idle period and before the second transaction commences.

11. The data communication apparatus of claim 9, wherein the controller is further configured to:
cause the line driver to hold the wire at a ground voltage defined for the master device before the first transaction commences.

12. The data communication apparatus of claim 11, wherein the first voltage level and the second voltage level are positive with respect to the ground voltage.

13. The data communication apparatus of claim 11, wherein the first voltage level and the second voltage level are negative with respect to the ground voltage.

14. The data communication apparatus of claim 9, wherein the coding circuit is further configured to encode and decode the first data using pulse amplitude modulation.

15. The data communication apparatus of claim 9, wherein the coding circuit is further configured to encode and decode the first data using pulse width modulation.

16. The data communication apparatus of claim 9, wherein the coding circuit is further configured to encode and decode the second data using pulse position modulation.

17. A method of data communication at a slave device, comprising:
extracting power from a wire of a one-wire serial bus, wherein the wire is maintained at or above a first voltage level during each of a plurality of transactions conducted over the one-wire serial bus;
participating in a first transaction by receiving a first signal that encodes first data, wherein the first signal transitions within a voltage range defined by the first voltage level and a second voltage level; and
encoding second data in a second signal transmitted on the wire during a second transaction, wherein the second signal transitions within the voltage range defined by the first voltage level and the second voltage level.

18. The method of claim 17, wherein the wire is driven by a master device to the first voltage level during an idle period and before the second transaction commences, and wherein the master device continues driving the wire while the second signal is transmitted.

19. The method of claim 17, wherein the wire is at a ground voltage defined for the slave device before the first transaction commences, and wherein the first voltage level and the second voltage level are positive with respect to the ground voltage.

20. The method of claim 17, wherein the wire is at a ground voltage defined for the slave device before the first transaction commences, and wherein the first voltage level and the second voltage level are negative with respect to the ground voltage.

21. The method of claim 17, wherein the first data is encoded using pulse amplitude modulation.

22. The method of claim 17, wherein the first data is encoded using pulse width modulation.

23. The method of claim 17, wherein the second signal is transmitted using pulse position modulation.

24. A data communication apparatus configured to operate as a slave device, comprising:
a power circuit coupled to a wire of a one-wire serial bus and configured to extract power from the wire when the wire is actively driven by another device, wherein the wire is maintained at or above a first voltage level during each of a plurality of transactions conducted over the one-wire serial bus;
a coding circuit configured to encode and decode data in one or more signals transmitted over the one-wire serial bus; and
a controller configured to:
participate in a first transaction by causing the coding circuit to decode first data from a first signal received from the wire, wherein the first signal transitions within a voltage range defined by the first voltage level and a second voltage level; and
participate in a second transaction by causing the coding circuit to encode second data in a second signal transmitted on the wire, wherein the second signal transitions within the voltage range defined by the first voltage level and the second voltage level.

25. The data communication apparatus of claim 24, wherein the wire is driven by a master device to the first voltage level during an idle period and before the second transaction commences, and wherein the master device continues driving the wire while the second signal is transmitted.

26. The data communication apparatus of claim 24, wherein the wire is at a ground voltage defined for the slave device before the first transaction commences, and wherein the first voltage level and the second voltage level are positive with respect to the ground voltage.

27. The data communication apparatus of claim 24, wherein the wire is at a ground voltage defined for the slave device before the first transaction commences, and wherein the first voltage level and the second voltage level are negative with respect to the ground voltage.

28. The data communication apparatus of claim 24, wherein the coding circuit is further configured to encode and decode the first data using pulse amplitude modulation.

29. The data communication apparatus of claim 24, wherein the coding circuit is further configured to encode and decode the first data using pulse width modulation.

30. The data communication apparatus of claim 24, wherein the coding circuit is further configured to encode and decode the second data using pulse position modulation.
